(19) United States
(12) Patent Application Publication
(10) Pub. No.: US 2013/0031028 A1
(43) Pub. Date: Jan. 31, 2013

(54) Exchange System Supporting Cloud Computing

(71) Applicant: Ian John MARTIN, Surrey (GB)

(72) Inventor: Ian John MARTIN, Surrey (GB)

(73) Assignee: BANK OF AMERICA, Charlotte, NC (US)

(21) Appl. No.: 13/190,220

(22) Filed: Jul. 25, 2011

(51) Int. Cl. G06Q 30/00

(52) U.S. Cl. 705/400

(57) ABSTRACT

A cloud exchange system processes transactions for cloud computing services. Cloud resources may be viewed as commodities, in which cloud customers may be dependent on cloud providers to provide hosted centralized computer facilities. The cloud customer may move computing services in the form of one or more virtual machines by buying a contract that specifies the cloud services and is purchased through the cloud exchange system. The cloud exchange system may receive a request from the cloud customer and an offer from a cloud provider for a cloud service and may match the request and the offer to obtain matched attributes. One of the available contracts may be selected by the cloud exchange system based on the matched attributes of the request and the offer, where the selected contract specifies the cloud service. A transaction charge for the transaction may be determined from at least one of the matched attributes.

### FIELD

Aspects of the embodiments relate to a computer system that processes request and offer data that support transactions for cloud computing services.

### BACKGROUND

Cloud computing may refer to the use and access of multiple server-based computational resources via a digital network so that a cloud user may access the server resources using a client device over a digital network (e.g., the Internet) to a service provider in the cloud (often referred as “The Cloud”). Cloud computing may provide computation, software, data access, and storage services that do not necessarily require end-user knowledge of the physical location and configuration of the system that delivers the services. Parallels to this concept may be drawn with the electricity grid, in which end-users consume power without needing to understand the component devices or infrastructure required to provide the service.

A cloud user typically uses a client device such as a laptop or desktop computer, pad computer, smart phone, or other computing resource with access to a cloud system via the Internet. The cloud may provide server-based applications and all data services to the cloud user. If the cloud user wishes to create a document using a word processor, for example, the cloud may provide a suitable application running on the server that displays work done by the cloud user on the client device web browser display. Memory allocated to the client device's web browser may be used to make the application data appear on the client system display, but all computations and changes may be processed by the cloud servers and the final results stored on the cloud servers. Consequently, performance of the cloud application is typically dependent upon the network.

The cloud provider may pool the processing power of multiple remote computers in the cloud to achieve routine tasks such as backing up of large amounts of data, word processing, or computationally intensive work. These tasks may be difficult, time consuming, or expensive for an individual user or a small company to accomplish, especially with limited computing resources and funds. However, with cloud computing, a cloud user may utilize a simple computer with a network connection in order to make requests to and receive data from the cloud. Computation and storage may be divided among the remote computers in order to handle large volumes of both, thus the client need not necessarily purchase expensive hardware or software to handle the task. The outcome of the processing task may be returned to the client device over the network.

With many traditional systems, computing tasks are not possible without the installation of application software on a user's computer. A user buys a license for each application from a software vendor and obtains the right to install the application on one computer system. In contrast, with cloud computing, applications may be provided and managed by the cloud provider and/or data may be remotely stored in the cloud resources. Consequently, a cloud user typically does not download and install certain applications on a user's device or computer that might otherwise be locally installed, because the processing and storage may be at least partially maintained by the cloud server.

Many technical analysts view cloud computing as being a paradigm shift, in which computing migrates from a client's computer to the cloud. Moreover, the potential revenue generated by cloud computer is huge. For example, some analysts predict that the worldwide market for cloud computing will grow to somewhere from $400B to $2T by the year 2020. Even a small percentage of the projected amount is huge.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects as disclosed herein may address one or more of the issues mentioned above by disclosing methods, computer readable media, and apparatuses that process transactions for cloud services for a cloud customer from a cloud provider through a cloud exchange. According to an aspect, for example, cloud resources may be viewed as commodities, resulting from a paradigm shift in the Information Technology (IT) industry. Cloud customers may be dependent on cloud providers to provide hosted centralized computer facilities as cloud customers are retrenching to their core businesses while cloud providers provide the appropriate IT infrastructure based on service level agreements (SLAB) and operating level agreements (OLAs). Cloud customers may be motivated for a number of reasons. For example, data centers, ranging from silos to warehouse scales of computing, are migrating from physical to virtual forms. Data centers may be restrained by power/cooling and electrical power requirements as well as real estate limitations so that building new data centers may be difficult and costly. Moreover, as a cloud customer may have increasing IT requirements, the cloud customer may have a constrained IT budget.

Accordingly, cloud services may provide an economically viable alternative to supporting equivalent services on the customer's own computing resources. As an alternative to buying a computer, the customer may transfer at least some computing services to one or more virtual machines that are offered by a cloud provider. The cloud customer may further investigate whether cloud services may be supported by another cloud provider at a lower price through a cloud exchange.

According to another example aspect, a cloud exchange receives a request from a cloud customer and an offer from a cloud provider for a cloud service and matches the request and the offer to obtain matched attributes. One of the available contracts is selected by the cloud exchange based on the matched attributes of the request and the offer, where the selected contract specifies the cloud service. A transaction fee for the transaction may be determined from at least one of the matched attributes.

According to another example aspect, a cloud exchange receives a request from a cloud customer, and an offer from a cloud provider. A matching engine matches the request and offer by comparing attributes contained in the request and the offer. The cloud exchange may then generate a contract description to specify the cloud service. Indications may be received from the cloud customer and the cloud provider that is indicative of an acceptance of the contract description. A contract may be generated from the contract description and signed by both parties.

According to another example aspect, a cloud exchange may provide the venue for the buying and selling of cloud products and may allow the sale of financial derivatives based on transactions of cloud products. The financial derivatives may include swaps and options. For example, a cloud consumer may buy an option on a certain amount of cloud resources in the years 2012 and 2013 on prices agreed now (in the year 2011). Consequently, different types of financial products that are approved by the cloud exchange may be traded.

With another example aspect, when a single cloud provider cannot support the entire customer request, the cloud provider may partner with another cloud provider. For example, a first cloud provider may meet all request requirements but may not have enough processing capacity to satisfy the request. In such a case, the first cloud provider and a second cloud provider may jointly support the cloud service for the cloud customer.

Any of the above or other aspects as disclosed herein may be implemented in the form of a tangible and/or non-transitory computer-readable medium storing computer-executable instructions that, when executed, cause a computer or other apparatus to perform one or more of the functions and/or process steps described herein. Any of the above or other aspects as disclosed herein may further be implemented in the form of a computer, or system thereof, that is configured to perform one or more of the functions and/or process steps described herein.

These and other aspects are discussed in greater detail throughout this disclosure, including the accompanying drawings, with reference to various example embodiments.

### BRIEF DESCRIPTION OF THE DRAWINGS

The present disclosure is illustrated by way of example and not limited in the accompanying figures, in which like reference numerals indicate similar elements and in which:

FIG. 1 illustrates an example of an example computing system environment that may be used in accordance with an aspect of the disclosure.

FIG. 2 shows an illustrative system for implementing example embodiments in accordance with an aspect of the disclosure.

FIG. 3 shows an example computer system that supports transactions between cloud customers and cloud providers for cloud services in accordance with an aspect of the disclosure.

FIG. 4 shows an example process that may be executed by the computer system shown in FIG. 3 in accordance with an aspect of the disclosure.

FIG. 5 shows an example process that supports transactions between cloud customers and cloud providers for cloud services in accordance with an aspect of the disclosure.

FIG. 6 shows examples of attributes associated with a transaction for cloud services in accordance with an aspect of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized, and that structural and functional modifications may be made, without departing from the scope and spirit of the present disclosure.

A cloud service may provide external hardware and/or software resources to a cloud user (who may be referred as a cloud customer of the cloud service). A cloud service may be any network-based service (e.g., the Internet) and may refer to any one or more of several personal or business services delivered over the network. Such a service may be anything from, e.g., Web-based email to inventory control and database processing. Because the service provider may host both the application and the data, the cloud user may be able to use the cloud service from anywhere. For example, a cloud service may provide hardware and operating system (OS) infrastructure, in which a cloud user deploys the cloud user's or cloud provider's applications on the cloud's servers. A cloud user may have as much or as little of a cloud service as the cloud user needs at any given time. The cloud service may be managed by the cloud provider so that the cloud user may need only a personal computer and network access. In accordance with some cloud models, a cloud provider may supply the hardware infrastructure and the software product and may interact with the cloud user through a front-end portal.

In accordance with various aspects of the embodiments, cloud resources may be viewed as commodities because of a paradigm shift in the Information Technology (IT) industry. Cloud computing is rapidly evolving from a technology focused industry to a service based industry that is dependent on providers of hosted centralized computer facilities. On reason is that organizations and industries (cloud customers) are retrenching to their core business and look to third parties (cloud providers) to provide the appropriate IT infrastructure against service level agreements (SLAs) and operating level agreements (OLAs).

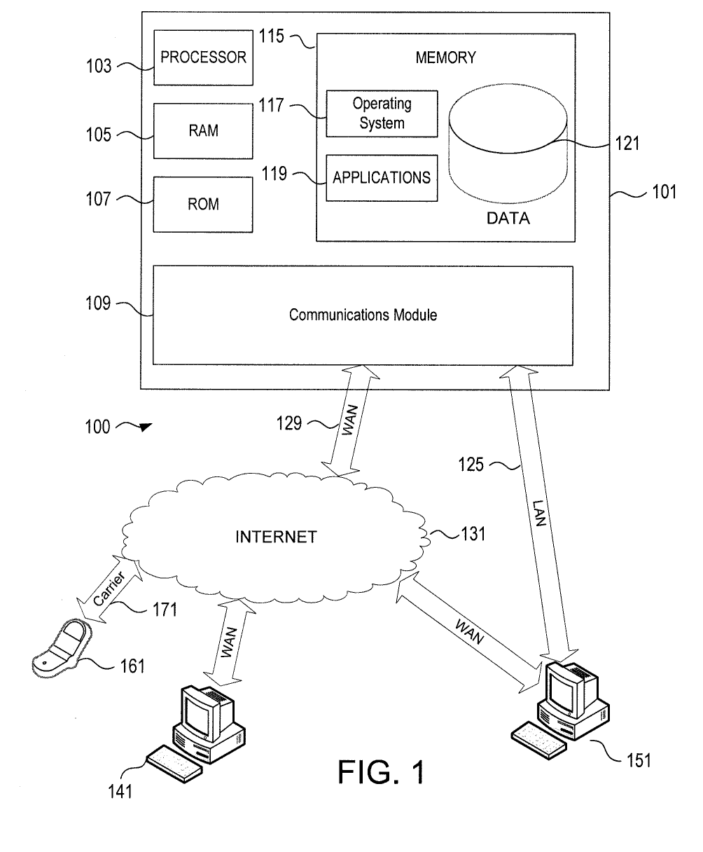

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of tangible and/or non-transitory computer readable media capable of storing information such as computer-executable instructions and/or other types of data. Computer readable media may be any media that may be accessed by computing device 101 and include both volatile and nonvolatile media, removable and non-removable media implemented in any method or technology for storage of information such as computer readable instructions, data structures, program modules, or other data. By way of example, and not limitation, computer readable media may comprise a combination of computer storage media and communication media.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners. Exemplary usages include scanning and converting paper documents, e.g., correspondence, receipts, etc. to digital files.

RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware and/or firmware.

Computing device 101 may operate in a networked environment supporting connections to one or more remote computing devices, such as computing devices 141, 151, and 161. The computing devices 141, 151, and 161 may be, for example, personal computing devices or servers that include many or all of the elements described above relative to the computing device 101. Computing device 161 may be, for example, a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101 may include computer executable instructions for invoking user functionality related to communication including, for example, email, short message service (SMS), and voice input and speech recognition applications.

Embodiments of the disclosure may include forms of computer-readable media that may include any available media that can be accessed by computing device 101. Although not required, various aspects described herein may be embodied as a method, data processing system, or computer-readable medium storing computer-executable instructions.

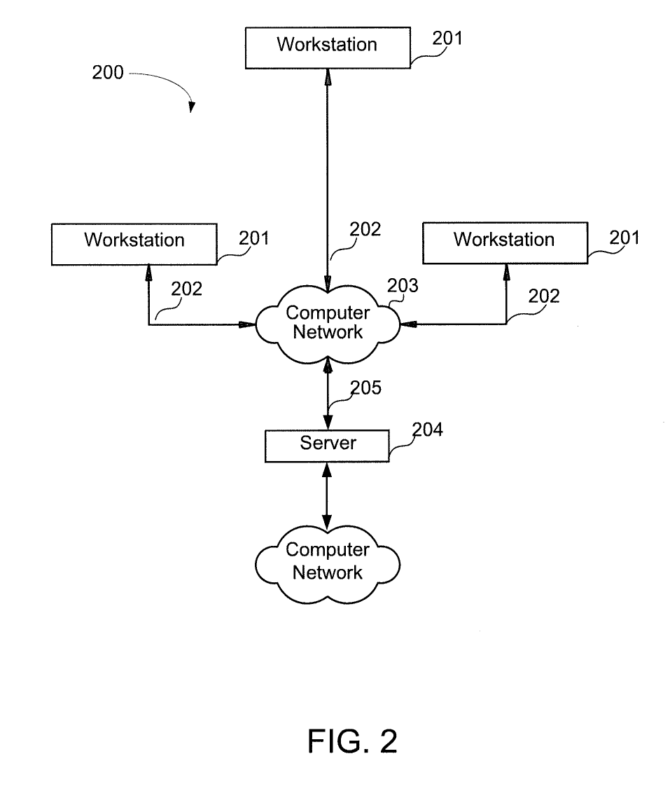

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable computing device, such as a server, processor, personal computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc., or any combination thereof.

The steps that follow in the Figures may be implemented by one or more of the components in FIGS. 1 and 2 and/or other components, including other computing devices.

As previously discussed, cloud resources may be viewed as commodities, resulting from a paradigm shift in the Information Technology (IT) industry. Cloud customers are dependent on cloud providers to provide hosted centralized computer facilities as cloud customers are retrenching to their core businesses while cloud providers provide the appropriate IT infrastructure based on service level agreements (SLAs) and operating level agreements (OLAs). Cloud customers may be motivated for a number of reasons. For example, data centers, ranging from silos to warehouse scales of computing, are migrating from physical to virtual forms. Data centers are often restrained by power/cooling and electrical power requirements as well as real estate limitations so that building new data centers may be difficult and costly. Moreover, as a cloud customer may have increasing IT requirements, the cloud customer may have a constrained IT budget. The United States government, for example, may leverage cloud computing for a number of applications, accounting for 25% of its IT budget.

Cloud services may provide an economically viable alternative to supporting equivalent services on the customer's own computing resources. For example, as a hypothetical example, the cost to a customer may be $10,000 (in addition to the burden of planning) to buy and configure a server. However, if the customer were to transfer the computing services to one or more virtual machines (where each virtual may be assigned different tasks) offered by a cloud provider at $1 an hour, then with low usage, this alternative may be very economically attractable. However, with greater usage, the customer may wish to search for cloud services at a lower rate provided by other cloud providers.

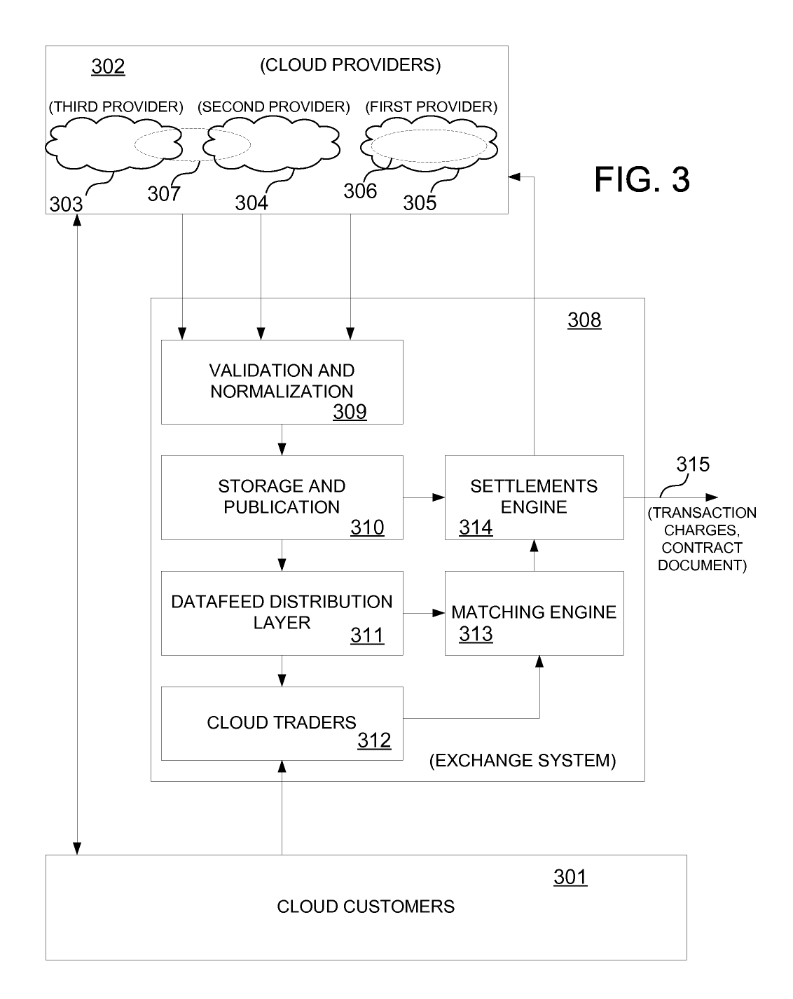

FIG. 3 shows an example computer system (which may be referred as a cloud exchange) 308 that supports transactions between cloud customers 301 (buyers) and cloud providers 302 (sellers and comprising cloud providers 303, 304, and 305) for cloud services 306 and 307 in accordance with an aspect of the disclosure. The computer system may include one or multiple computing devices. Cloud exchange 308 provides a mechanism for the trading of computing resources and/or storage resources provided by cloud computing providers 302 (who may be referred as suppliers) as commodities. The computing commodities may be traded in the same manner as other tradable commodities by service owners, service providers, and resellers. Cloud exchange 308 may enhance the standardization in the market and increase the liquidity in the marketplace. The combination of these two may decrease the time to market for those wishing to utilize cloud resources.

Cloud exchange 308 may include different components, including validator/normalizer 309, storage and publication 310, datafeed distribution layer 311, cloud trader interface 312, matching engine 313, and settlements engine 314. Validator and normalizer 309 may verify the validity of contracts (which may be expressed by an eXtensible Markup Language (XML)) submitted to cloud exchange 308. For example, validator and normalizer 309 may validate content to verify that the content of the contract conforms to standards and contracts. Storage and publication 310 provides a persistent store for the validated data. Datafeed distribution layer 311 provides synchronous and/or asynchronous mechanisms for accessing the contracts. Communications interface 312 interfaces to cloud traders wishing to buy and sell resources on behalf of cloud providers 302. Cloud customers (consumers) 301 wish to buy cloud resources. Matching engine 313 then matches bids and asks from cloud customers and cloud providers, respectively. Settlement engine 314 then generates the payment settlement/contract 315, which may describe what cloud resource is and when it is available and may be expressed as an eXtensible Markup Language, as will be discussed herein.

Components 309-314 of computer exchange 308 may be implemented in various forms. For example, computer exchange 308 may be implemented by computer system 101 or server 204. Also, computer exchange 308 may be implemented as one or more ASICs or other integrated circuits storing or otherwise representing or executing instructions for performing operations as described in connection with one or more of any of the embodiments described herein. The instructions may be software and/or firmware instructions stored in a machine-readable medium and/or may be hard-coded as a series of logic gates and/or circuits in one or more integrated circuit chips and/or other circuit elements.

Cloud exchange 308 may provide a brokerage and exchange for cloud services 306 and 307. A universal language may be utilized to describe and trade cloud services. For example, a universal language may be developed based on an eXtensible Markup Language.

With some embodiments, cloud service 306 is supported by a single cloud provider 305. Cloud service 306 may be supported on one or more computing machines of cloud provider 305. The computer machines may comprise physical and/or virtual resources. Also, cloud service 307 may be supported by both cloud providers 303 and 304 when the cloud resources cannot be provided by a single cloud provider. In such a case, the cloud resources requested by cloud customer 301 may be partitioned for the plurality of cloud providers within the constraints of the requested attributes, for example, requested price and the number of instructions per second (often expressed by millions of instructions per second (MIPS) or an agreed Virtual Processing Unit (VPU) standard). Also, there may be separate contracts between each of the cloud providers 303 and 304 and cloud customer 301.

With some embodiments, cloud exchange 308 may support different models for cloud computing (which may be referred as “The Cloud”), including software as a service (SaaS), Platform as a Service (PaaS), and Infrastructure as a Service (IaaS).

SaaS may describe application programs offered through cloud computing (which may be referred as “The Cloud”). Cloud computing may differ from the classic client-server model by providing applications from a server that are executed and managed by a client's web browser, with no installed client version of an application required. SaaS may be considered as essentially hosted web based services. Centralization may give cloud service providers 302 complete control over the versions of the browser-based applications provided to clients, thus removing the need for version upgrades or license management on individual client computing devices.

IaaS may deliver computer infrastructure (typically a platform virtualization environment) as a service for cloud customer 301. Rather than purchasing servers, software, data-center space or network equipment, cloud customer 301 instead buys cloud resources as a fully outsourced service. Cloud providers 302 typically bill cloud services 306 and 307 on a utility computing basis, where the amount of cloud resources consumed typically reflect the level of activity.

PaaS may deliver a computing platform and/or solution stack as a cloud service 306 or 307, often consuming cloud infrastructure and sustaining cloud applications. PaaS may facilitate deployment of applications without the cost and complexity of buying and managing the underlying hardware and software layers.

With some embodiments, cloud exchange 308 may support the buying and selling of cloud products (e.g., cloud services 306 and 307) and may allow the sale of financial derivatives (e.g., swaps and options) based on transactions of the cloud products. For example, a cloud consumer may buy an option on a certain amount of cloud resources in the future on prices agreed now. Consequently, different types of financial products that are approved by cloud exchange 308 may be traded.

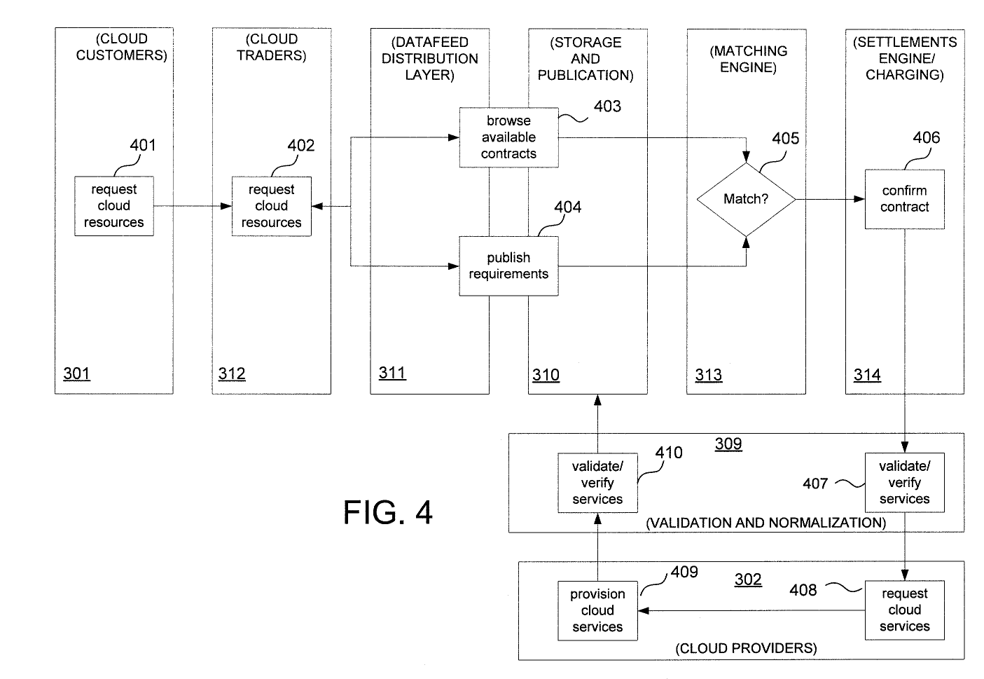

FIG. 4 shows an example process 400 that may be executed by cloud exchange 308 shown in FIG. 3 in accordance with an aspect of the disclosure. At block 401, cloud customer 301 requests cloud services 306 or 307. The requested services may be represented by different forms, including, but not limited to, text, pictorial, or a format based on an eXtensible Markup Language, which may be referred as Cloud XML (CXML) or Cloud eXchange Markup Language (Cloud-ML) as will be further discussed

At block 402, a description of the requested services is received by cloud traders through communications interface 312. At block 403, through datafeed distribution layer 311 and storage and publication component 310, a cloud trader browses for available contracts that are currently offered by cloud providers 302. The cloud trader also publishes the requirements contained in the customer request at block 404.

At block 405, matching engine 313 attempts to match the published requirements with one or more of the available contracts. At block 406 settlements engine 314 analyzes attribute matches to confirm whether one or more of the available contracts are consistent with the cloud customer's request. For example, some of the attributes of the request and the available contract must match to satisfy the customer's request while other attributes may not be specified in the customer request.

With some embodiments, if none of the available contracts match the published requirements or if the pending contract cannot be confirmed at blocks 405 and 406, respectively, cloud exchange 308 may indicate to cloud customer that the request cannot be met at the current time.

Settlements engine 314 may determine a transaction fee for the cloud customer and/or cloud provider based on one or more of the transaction attributes. For example, the transaction fee may be based proportional to the amount of MIPS, storage space and/or duration of availability.

At block 407, validator and normalizer 309 validates that content to verify that the content of the matched available contract conforms to standards and procedures that may be established by cloud exchange 308, cloud customer 301, and/or cloud providers 302. If the content is validated, the content is then passed to the cloud provider who submitted the selected available contract at block 408. The cloud provider then may provision the contracted services at block 409. At block 410, validator and normalizer 309 verifies and validate cloud services provided to cloud customer 301 by the contracted cloud provider. The results are then sent to storage and publication component 310.

Referring back to block 405, while the contract for the cloud service may be selected from one of the available contracts, with some embodiments, a contract may be generated from the matched attributes of a bid (e.g., an request) and an ask (e.g., an offer or an available contract). The contract may then be sent to cloud customer 301 and/or the selected cloud provider 303, 304, or 305.

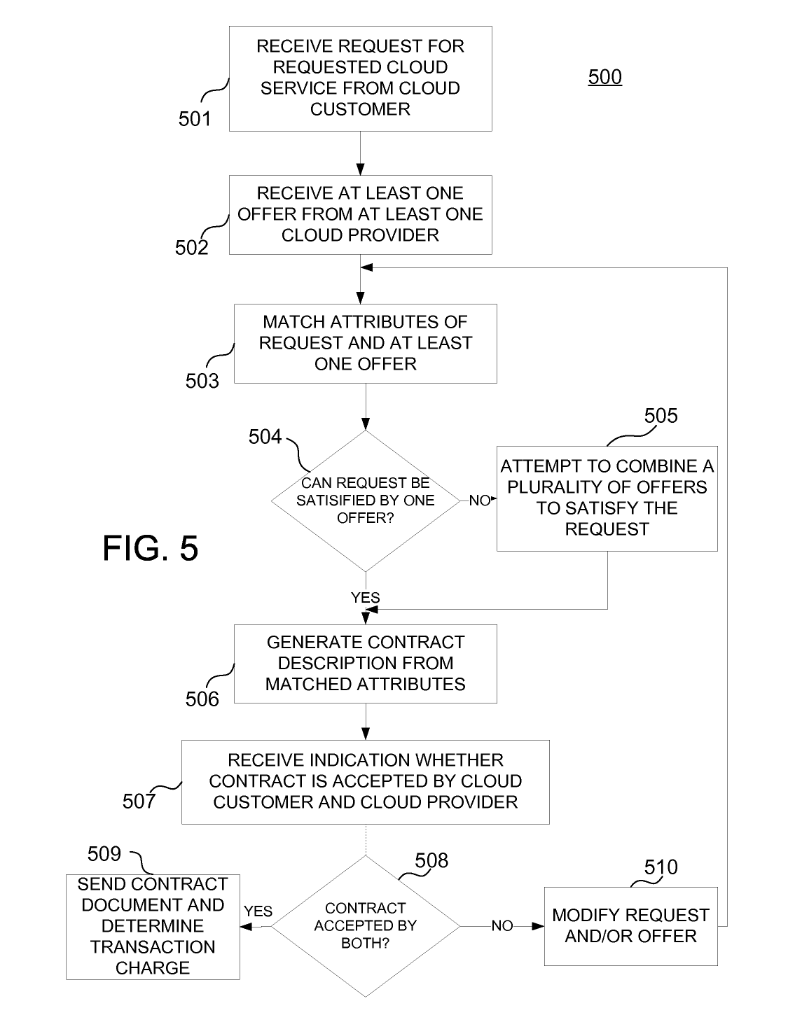

FIG. 5 shows process 500 that supports transactions between cloud customers (buyers) and cloud providers (sellers) for cloud services in accordance with an aspect of the disclosure. For example, process 5 may execute on a computing system, for example, computing device 101 or server 204, one or more ASICs, or other integrated circuits having instructions for performing process 500.

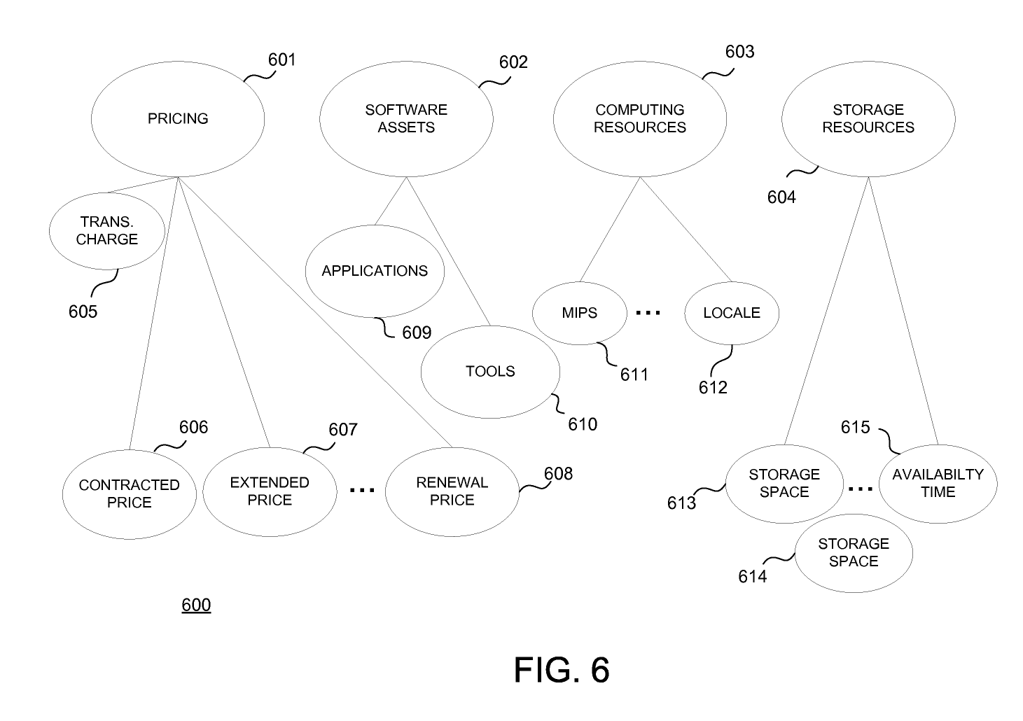

A cloud transaction system receives a request for a requested cloud service from a cloud customer and at least one offer from at least one cloud provider at blocks 501 and 502, respectively. Both the request and the offer may be described in a descriptive format. For example, associated attributes for a cloud service (e.g., as shown in FIG. 6) may be represented by Cloud eXchange Markup Language (CXML). The following CXML listing is an example that specifies resource allocation (e.g., random access memory and hard disk drive storage), availability information (e.g., when and how long), and bidding information (e.g., currency of bid per unit time).

```
<CXML>
    <VPU type=“uncontended”>2</VPU>
    <RAM measure=“GB”>4</RAM>
    <Storage measure=“GB” IOPS=“200”>50</Storage>
    <Availability>
        <AvailableFrom format=
“YYYY-MM-DDThh:mm:ss.sTZD”>2011-07-19T19:20:30.45+01:00
</AvailableFrom>
        <Duration format=“hh:mm:ss.s”>120:00:00.0</Duration>
    </Availability>
    <BID currency=“USD” unit=“perhour”>1.00</BID>
</CXML>
```

At block 503, some or all of the indicated attributes of the request and the offer are compared to determine if the corresponding attribute match. If selected attributes match, as determined at block 504, a contract document (for example, expressed in CXML) is generated at block 506 and may be sent to the cloud customer and/or cloud provider for approval. If the contract is accepted, each party may execute the contract by electronically signing the document at block 507. If both parties sign the document at block 508, the executed contract may be sent to the parties (e.g., electronically or paper), and a transaction fee is determined at block 509. For example, the cloud customer and/or the cloud provider may be charged a predetermined percentage of the contract price. However, if the pending contract is not accepted by both parties, the pending contract may be renegotiated by the cloud customer and cloud provider by modifying one or more contract attributes at block 510. If so, blocks 503-509 may be repeated.

Referring back to block 505, when a single cloud provider cannot support the entire customer request (for example, if the available computing resources of the cloud provider are not sufficient for the requested computing resources), the cloud provider may partner with another cloud provider. For example, a first cloud provider may meet all other request requirements but may not have enough processing capacity to satisfy the request. In such a case, the first cloud provider and a second cloud provider may jointly support the cloud service (e.g., cloud service 307 as shown in FIG. 3) for the cloud customer.

With some embodiments, cloud exchange 308 may perform contract verification. For example, cloud exchange 308 may verify that the CXML specification is well formed and that the units etc. used within it are in accordance with agreed standards. Also, cloud exchange 308 may verify that actual service provided to cloud customer 301 is in accordance with the contract.

FIG. 6 shows attributes 600 associated with a transaction for cloud services in accordance with an aspect of the disclosure. Some or all of the attributes 601-615 may be included in the customer request, cloud provider's offer, and/or contract.

Cloud resources may include computing resources 603 and/or storage resources 604. Computing resources 603 may further include a MIPS attribute 611 and a locale attribute 612 (for example, where the resource is located), associated random access memory space and disc memory space, time of availability, and duration of availability. The locale of the cloud resources also may be specified for various reasons, including regulatory constraints and software licensing restrictions.

Cloud services may also support software applications and tools that are stored and execute in the cloud. Applications may be off-the shelf software (for example, word processing, spreadsheets, and presentation software) or may be customized for the cloud customer. Access to specific applications and software tools may be specified by attributes 602, 609, and 610.

Additional attributes 601 may be directed to a pricing agreement set forth in a contract. The price for the cloud services may be specified by attribute 606, while the transaction fee for the contract is specified by attribute 605. Also, attribute 607 may specify pricing if the cloud customer wishes additional resources if the contracted resources are exceeded.

Attributes 601-615 may be expressed using a standard or custom-developed meta-language for specifying hosted/cloud products. For example, with some embodiments, as previously discussed, the attributes may be expressed by an eXtensible Markup Language (referred as CXML). The use of CXML allows for a homogeneous description of cloud commodities in a manner that can be traded on cloud exchange 308 described in the picture.

Various aspects have been described by way of example embodiments. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments.

1. An apparatus supporting a transaction for a cloud service, the apparatus comprising:
a memory; and
a processor coupled to the memory and configured to perform, based on instructions stored in the memory:
receiving a request from a cloud customer and an offer from a cloud provider for the cloud service;
matching the request and the offer to obtain matched attributes;
selecting one contract from available contracts based on the matched attributes of the request and the offer, said one contract specifying the cloud service; and
determining a transaction fee for the transaction from a matched attribute.

2. A method for processing a transaction for a cloud service, the method comprising:
receiving, by a computer system, a request from a cloud customer, a first offer from a first cloud provider, and a second offer from a second cloud provider for the cloud service;
matching, by the computer system, the request, the first offer, and the second offer to obtain matched attributes; and
generating, by the computer system, data representing a contract description from the matched attributes of the request and the first offer, the contract description specifying the cloud service.

3. The method of claim 2, further comprising:
determining, by the computer system, a transaction fee from the contract description.

4. The method of claim 2, further comprising:
receiving, by the computer system, a customer indication whether the cloud customer accepts the contract description and a provider indication whether the first cloud provider accepts the contract description.

5. The method of claim 2, further comprising:
sending a signed contract document to the cloud customer and the first cloud provider.

6. The method of claim 2, further comprising:
when the first offer does not meet a requirement of the request, combining the first offer with a third offer from a third cloud provider.

7. The method of claim 2, further comprising:
rejecting the second offer based on a mismatched attribute with the request.

8. The method of claim 3, wherein the determining comprises:
determining the transaction fee from a matched attribute.

9. The method of claim 2, wherein the cloud service is executed over a plurality of virtual computers.

10. The method of claim 2, wherein a matched attribute comprises a price for the cloud service.

11. The method of claim 2, wherein the contract description is based on XML (eXtensible Markup Language).

12. A cloud exchange configured to process a transaction for a cloud service, comprising:
a communications interface configured to receive a request for the cloud service from the cloud customer;
a distribution component configured to access a plurality of available contracts for the cloud service from a cloud provider and to publish requirements for the request from the cloud customer;
a matching engine configured to match an attribute from one of the plurality of available contracts and the requirements; and
a settlements engine configured to confirm said one available contract.

13. The cloud exchange of claim 12, wherein the settlements engine is configured to determine a transaction fee for the transaction.

14. The cloud exchange of claim 12, further comprising:
a validation and normalization component configured to verify that content of said one available contract confirms to established procedures of the cloud exchange.

15. A cloud exchange system comprising:
a memory; and
a processor coupled to the memory and configured to perform, based on instructions stored in the memory:
receiving a request from a cloud customer and an offer from a cloud provider for a cloud service;
matching the request and the offer to obtain matched attributes;
generating a contract for a transaction based on the matched attributes, wherein the contract specifies the cloud service; and
verifying that content of the contract confirms to established procedures of the cloud exchange system.

16. The apparatus of claim 15, wherein the at least one processor is further configured to perform:
determining a transaction fee for the transaction from at least one of the matched attributes.

17. The apparatus of claim 15, wherein the generating comprises:
generating a contract description from the matched attributes of the request and the offer.

18. The apparatus of claim 15, wherein the generating comprises:
selecting the contract from a plurality of available contracts based on the matched attributes.

19. A non-transitory computer-readable medium storing computer-executable instructions that, when executed, cause a computer to perform operations comprising:
receiving a request from a cloud customer and an offer from a cloud provider for a cloud service;
matching the request and the offer to obtain matched attributes; and
selecting, for a transaction, one contract of available contracts based on the matched attributes of the request and the request, said one contract specifying the cloud service.

20. The non-transitory computer-readable medium of claim 19, wherein the computer-executable instructions, when executed, cause the computer to perform:
determining a transaction fee for the transaction from at least one of the matched attributes.

21. The cloud exchange of claim 12, wherein the distribution component is implemented by a computer.

22. The cloud exchange of claim 12, wherein the matching engine is implemented by a computer.

23. The cloud exchange of claim 12, wherein the settlements engine is implemented by a computer.
